(19) United States
(12) Patent Application Publication
(10) Pub. No.: US 2009/0058819 A1
(43) Pub. Date: Mar. 5, 2009

(54) SOFT-USER INTERFACE FEATURE PROVIDED IN COMBINATION WITH PRESSABLE DISPLAY SURFACE

(76) Inventors: Richard Gioscia, Santa Clara, CA (US); Eric Liu, Santa Clara, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/849,133

(22) Filed: Aug. 31, 2007

(51) Int. Cl. G06F 3/041; H04B 1/38; H04M 1/00

(52) U.S. Cl. 345/173; 455/566

(57) ABSTRACT

A mobile computing device having a display assembly that is configured to otherwise capable of distinguishing contact by a magnitude of force or inward movement of the display surface as a whole.

### TECHNICAL FIELD

The disclosed embodiments to a display interface for a computing device.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

At the same time, there has been added focus to how displays are presented, particularly with the increase resolution and power made available under improved technology. Moreover, form factor consideration such as slimness and appearance are important in marketing a device.

### BRIEF DESCRIPTION OF THE DRAWINGS

FIG. 1 is a top view of a mobile computing device configured according to an embodiment of the invention.

FIG. 2A is a simplified and illustrative side cross-sectional view of a display assembly of the mobile computing device of FIG. 1, as viewed along lines A-A, according to an embodiment.

FIG. 2B illustrates an alternative implementation for a display assembly of a mobile computing device of FIG. 1, as viewed along lines B-B, according to an embodiment.

FIG. 2C illustrates an alternative implementation for display assembly 220, as viewed along lines A-A of FIG. 1.

FIG. 3 illustrates a programmatically implemented method by which a device or its processing resources may process input made through contact with a display surface of the device, under an embodiment.

FIG. 4A thru FIG. 4C illustrate one embodiment in which a device includes a sliding housing construction in connection with a moveable display and soft-features, according to an embodiment.

FIG. 5A and FIG. 5B illustrate the device with sliding housing construction from a side perspective, in both a contracted and extended state, according to an embodiment.

FIG. 6A illustrates an implementation of an embodiment in which soft buttons are iconic in appearance on a display surface, so as to be selectable to perform a specific function or application operation, according to an embodiment.

FIG. 6B illustrates an implementation of an embodiment in which a soft keyboard is provided on an inwardly moveable display region of a mobile computing device, according to an embodiment.

FIG. 7 is a simplified hardware diagram of a computing device configured to implement one or more embodiments of the invention.

### DETAILED DESCRIPTION

Embodiments described herein provide for a mobile computing device having a pressable display assembly on which soft buttons and other features can be selected. As will be described, a contact-sensitive display assembly for a computing device is provided, having a pressable display surface that, when pushed by user-interaction, triggers a processor of the computing device to recognize the interaction as being deliberate or otherwise distinguishable from contact that involves grazing the display surface or providing trace input.

In one embodiment, the display assembly provides a surface that is pressable by enabling the display surface (or the whole assembly) to be moved inwards to actuate or trigger a contact element. Thus, the amount of distance that the display surface travels as a result of user-contact may determine whether the user-contact satisfies a threshold for considering the contact deliberate, or otherwise distinguishable from, for example, the user grazing the display surface.

In another embodiment, the display assembly may include a force sensor that can detect force applied to a designated region of the display surface. The force sensor may operate independent of any other sensor that can detect a position of an object. The display surface may travel a negligible amount in order to trigger the force sensor. The force sensor may measure the amount of force applied to the display surface by a particular user-contact in order to determine whether the contact satisfies a threshold for determining that the contact was deliberate or otherwise distinguishable from, for example, the user grazing the display surface.

With embodiments described herein, a mechanism (e.g. switch element, force sensor) may be combined with a display assembly in order to identify when a user-contact with the display surface satisfies a threshold criteria. Responsive to the threshold criteria being satisfied, the processing resources of the mobile computing device determine the position of an object using position sensors. The position is determined at the time the contact was made (e.g. just before or just after when the user-contact occurred). In one embodiment, the position information is then interpreted based on an assumption that the user-contact was deliberate. The user-contact may be distinguished from incidental contact, or from trace input. For example, the user-contact may be interpreted as selection input when the threshold criteria is met.

Among other benefits, embodiments described herein promote the use of soft keys, buttons and other features on mobile computing devices. For example, conventional mobile computing devices often have buttons that have pre-designated functions of performing application launches, software/hardware control or actions. Embodiments described herein enable some or all of such pre-designated buttons to be presented as soft keys or buttons. As soft keys or buttons, more area on a face of a mobile computing device may be used for display area, and fewer mechanical buttons or features are necessary. Embodiments described herein promote the use fewer mechanical buttons, which provides a cost savings. Furthermore, the use of soft keys and buttons enables optional dynamism with the manner the keys and buttons are presented, configured and used.

As used herein, the term “soft” means displayed. For example, a “soft button” is a displayed button.

Additional embodiments described herein provide for a mobile computing device that combines the use of soft user-interface features and mechanical switching. According to one or more embodiments, a user is able to interact with a contact-sensitive display of a mobile computing that is movable inward with respect to the housing. The inward movement of the display enables certain types of user-interactions with the contact-sensitive display to be recognized as a particular class or type of input.

Still further, one or more embodiments enable a device to provide certain button functionality through use of a contact-sensitive display that is push-sensitive. For example, the display surface may travel slightly inwards and/or interact with a force sensor. In this way, a contact with the display surface actuates an underlying switch or contact element. In particular, one or more embodiments enable a device to provide selectable icons or soft-buttons on a region of a contact-sensitive display. The user may select a particular soft feature (e.g. such as a displayed button) by sufficiently contacting the soft feature on the display surface to actuate the processor into interpreting the contact as selection input. As selection input, the processor may use the position of the object making the sufficient contact to determine the coinciding soft feature that encompasses the coordinates of the object's position.

Among other advantages, embodiments described herein enable many of the buttons or mechanical features normally found on devices such as mobile computing devices to be found on a display region of the device.

Embodiments described in this application may be implemented on any type of computer having a sensor aware display for detecting user-interaction. One type of computer on which embodiments described herein may be implemented is a mobile computing device, such as a cellular computing device, wireless messaging device, personal digital assistant, or hybrid/multi-functional device for enabling cellular voice and data transmissions. These devices typically have relatively limited display sizes, processing resources, and display area. The ease of use and flexibility provided by embodiments described herein has benefit to such devices, as input features and mechanisms described in connection with such embodiments compensates for the relatively more limited dimensions such devices typically have. However, embodiments described herein may also be implemented by desktop computers, laptop computers, and large profile computers.

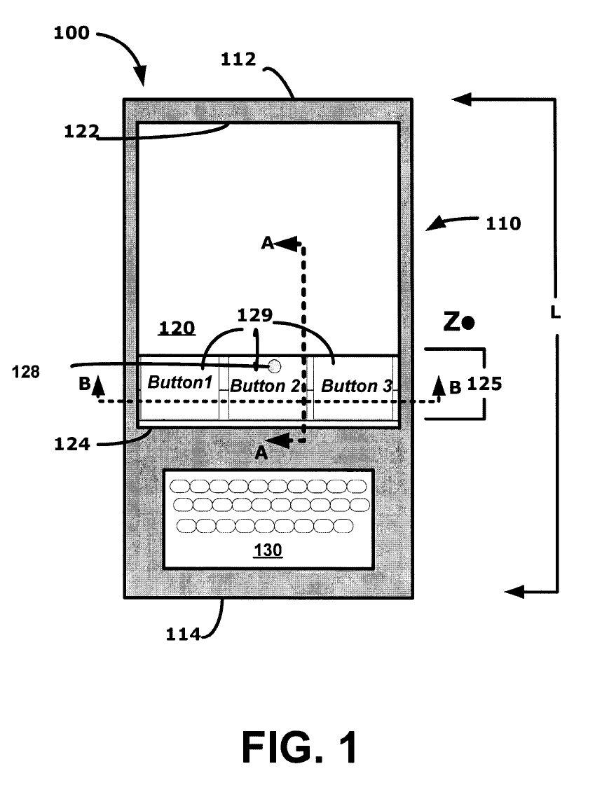

FIG. 1 is a top view of a mobile computing device configured according to an embodiment of the invention. A mobile computing device 100 may correspond to, for example, a device capable of voice and data communications (including messaging) over cellular or other wireless networks. In an embodiment, the device 100 includes a housing 110 having a front face 118 with a length L. The length L may be defined as a distance extending (approximately) between a top end 112 and a bottom end 114 of the housing. A display surface 120 may be provided as part of the front face 118. In one implementation, a keypad 130 is provided between the bottom end 114 and the display 120. The keypad 130 may correspond to a keyboard, a number pad, or any other set or arrangement of buttons/keys.

The display surface 120 use be integrated or coupled with sensors that detect presence of an object on the surface. Such sensors can provide information for determining the position of an object that either makes contact with or is in close proximity to display surface 120. In one embodiment, the display surface 120 is part of a display assembly that uses capacitive sensors, so that proximately held objects can also be contacted.

The housing 110 may contain one or more internal components, including processor and memory resources of the device. The processor may generate data that is displayed as content on the display surface 120. As will be described, an internal processor may also generate various soft features that are presented for use in combination with a mechanism for determining whether a detected user-contact is sufficient or satisfies some criteria for considering the contact as selection input and/or deliberate.

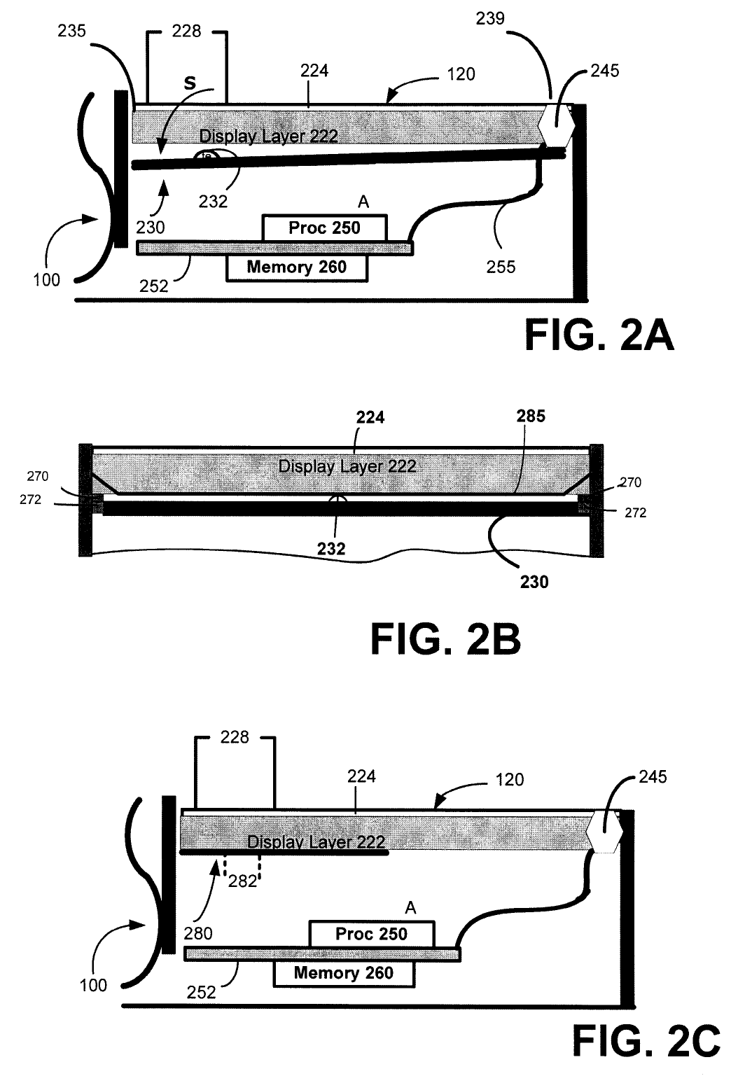

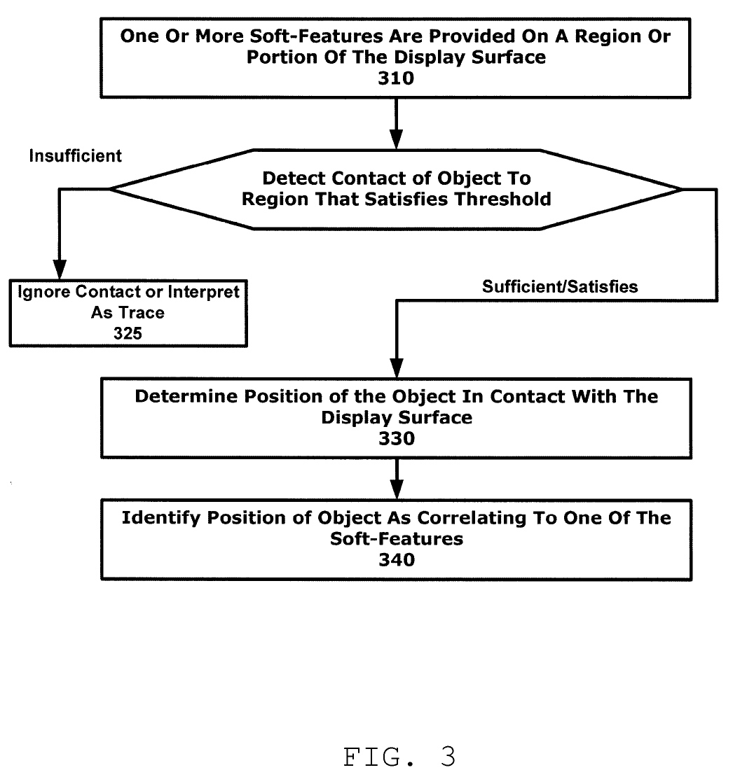

According to an embodiment, the display surface 120 is moveable inwards (as shown by directional axis Z), and a measure of the inward movement is determinative of whether the contact is sufficient. In one embodiment, the display surface 120 is pivotable inward. In an example such as shown by FIG. 2A, the bottom edge 124 of the display pivots inward, while the top edge 122 is hinged or pinned. Still further, one or both ends may be hinged or provided a hinged connection to the housing or underlying housing structure. As yet another alternative, the entire display surface 120 may be moveable. For example, as described with FIG. 2B, the display surface 120 may be part of a larger assembly that is supported and held together with a carriage. The carriage may traverse inward so as to enable the entire display surface 120 to move in, with or without pivot. The amount of inward movement may be slight. For example, the distance may be what is required to cause a snap dome electrical contact to collapse. FIG. 2A and FIG. 2B illustrate embodiments in which the display surface (or assembly) pivots or translates inward a measurable distance.

As an alternative or addition to being moveable inwards by pivot, the display surface 120 may be coupled with a force sensor that operates independent the position sensors that detect the position of the object. In one embodiment, the display assembly is coupled to or in contact with a force sensor that can detect (i) application of force on the display surface, and (ii) a magnitude of the applied force or of the moment resulting from the applied force. If the contact with the display surface 120 is performed with sufficient force to exceed a threshold, an embodiment provides that the processor interprets the contact by the object as deliberate, or otherwise differently than had the threshold not been met. FIG. 2C illustrates an embodiment in which a force sensor can detect application of force to the display surface, independent of surface sensors that detect position of the object in contact.

The amount of inward movement permitted for display surface 120 may be slight or negligible. In particular, almost no movement of the display surface 120 is needed if a force sensor is used. If inward travel measurement is used for the criteria, the distance may be that which is required to collapse a dome switch, which under one implementation, may be between 0.1 mm or 0.5 mm (e.g. 0.3 mm). Larger travel distances are also contemplated, such as in the range of 1-3 mm.

As described with an embodiment of FIG. 2A, an embodiment provides that the display surface 120 may be positioned over an electrical contact layer having one or more switches that actuate when inward movement of the display surface occurs. A switching event may thus result from the inward movement of the display surface 120. One or more embodiments provide that such a switching event is used to distinguish certain kinds of user-interactions with the display surface from incidental contacts. In one embodiment, the processor 250 (FIG. 2A) at least partially distinguishes whether a user-initiated contact with the display surface is a selection input by determining whether a switching event occurred (e.g. display surface moved inward) in connection with the contact with the display surface 120. The selection input may be distinguished from, for example, incidental contact that would not otherwise provide the combination of the position information and the inward movement of the display surface 120. As described with an embodiment of FIG. 2C, for example, the use of force sensors may alternatively be used to distinguish the selection input from, for example, incidental contact.

Accordingly, an embodiment provides that the device 100 provides an interface region 125 that overlap a threshold detector 128 underlying the display surface 120. In one embodiment, the threshold detector 128 may be in the form of a mechanical and/or electrical switch that can detect when the contact causes sufficient travel from the display surface. For example, the threshold detector 128 may be in the form of a mechanical switch. In another embodiment, the threshold detector 128 may be a force sensor that detects or determines where a force applied with the contact is sufficient. The interface region 125 may display various forms of user-interface features, including buttons 129 or icons (“soft buttons”). At the same time, the user-interaction with any portion of the interface region 125 may result in a contact event that is sufficient to be considered deliberate or distinguishable from grazing. In an embodiment, the occurrence of the contact event in connection with the user contacting a point in the interface region 125 is interpreted by the processor as a selection of the feature that is displayed (or alternatively most proximate) at the point of contact. Thus, for example, the user may select a soft button by pushing or deliberately contacting the soft button region of the display surface, similar to a mechanical button or feature.

One or more embodiments contemplate that soft buttons and features that are displayed for use with threshold detector 128 are provided within designated boundary or region that occupies only a portion of the overall area of the display surface 120. In one embodiment, the interface region 125 is provided at a lower region of the overall display surface 120, where the soft buttons 129 are provided.

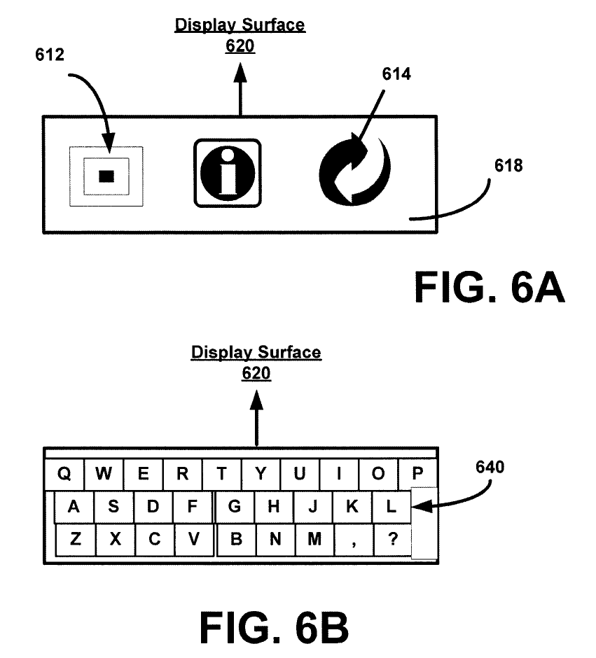

In one implementation, the soft buttons 129 are persistent and static. As a variation, the display may be powered to dim or power off in the region where the soft buttons 129 are provided, so as to make the soft buttons disappear. Still further, the region where the soft buttons 129 are provided may be dynamic, with ability to insert other soft features (e.g. see keyboard 630 of FIG. 6B), replace or eliminate existing soft buttons (temporarily or otherwise), reconfigure appearance of existing soft buttons 612 or include new functionality in the region with addition of different kinds of soft features. As yet another variation, the shape, size or location of the interface region 125 where the soft buttons 129 are provided may be altered or made configurable for the user. Still further, any of the variations described above may be enabled on one device through user-settings and/or configurations.

FIG. 2A is a simplified and illustrative side cross-sectional view of a display assembly of the mobile computing device of FIG. 1, as viewed along lines A-A, under one or more embodiments of the invention. According to an embodiment, the device 100 includes a display assembly 220 that has a display layer 222 and one or more surface sensor components 224 for determining position information of objects in contact or proximate to the surface. The display assembly 220 provides an exterior thickness, in the form of a layer or protective coat, that corresponds to display surface 120. The display layer 222 and sensor components 224 may be combined, or provided as separate thicknesses. The display layer 222 may correspond to, for example, a Liquid Crystal Display (LCD). The sensor components 224 may be capacitive sensors. In other implementations, resistive sensors may be used. The sensor components 224 enable the display surface 120 to be contact-sensitive. The display assembly 220 as a whole, or portions thereof (including just exterior layer or display surface 120) may be moveable inward by pivot or by translation (see FIG. 2B). The inward movement may be used to distinguish different types of interactions between the user and the display surface 120.

Still further, embodiments provide for use of optical sensors which can detect light variations resulting from objects passing over the display surface. In such implementations, mechanisms or techniques may be used to distinguish light variations that result from user-contact, as opposed to user motioning an object over the display. For example, a specific object may be used having a tip that creates light variation patterns that are distinguishable from more general motions that may result from other objects or non-contact interactions.

Additionally, with the housing 110, numerous internal components may provided, including the processor 250 and memory resources 260. The processor 250 may be provided on a substrate 252 and interconnected with an electrical contact layer 230 through, for example, a bus connector 255. In an embodiment in which optical sensors are used, one way in which incidental light variations may be distinguished from the light variations resulting from deliberate interactions (e.g. use touching of soft button) is through detection of inward movement of the display surface, as described with embodiments provided herein.

In an embodiment, the sensor components 224 detect the position of any object that comes in contact with the display surface 120. How and whether the position information is used may depend on whether a switch event occurs in connection with the contact. According to an embodiment, the electrical contact layer 230 underlies at least a region of the display assembly 220. One or more contact elements 232 may be provided on the electrical contact layer 230. FIG. 2A illustrates an embodiment in which the display assembly 220 is moveable through pivot at a bottom end 235 of the display surface 120. Under one embodiment, the bottom end 235 is the pivoting end, a top end 239 is hinged or otherwise pivotally connected to the housing. In an example provided by FIG. 2A, the top end 239 is coupled to an internal structure of the device via a hinge 245 or other pivot connection. This enables the top end 239 to move about the hinge 245. Spacing between the underlying electrical contact layer 230 and the bottom end 235 may diverge to provide room for the bottom end 235 to move inward. In one implementation, the amount of divergence may be relatively small-such as, for example, of the order of 1-3 mm.

Alternatively, the display assembly may be limited in pivot movement at top end 239. For example, the top end 239 may form a base from which the bottom end 235 cantilevers. Variations provide that both top and bottom end 235, 239 are hinged or otherwise pivotally coupled to a frame of the housing.

In an embodiment, when the display assembly 220 (or display surface 120) moves inward (either through pivot along rotational direction S or translation), pressure or contact may be applied onto the element(s) 232 of the electrical contact layer. Actuation of the element 232 may correspond to either the initial contact, or the release after the initial contact. For example, in a snap-dome implementation, the actuation may be provided for either the dome collapse or release. The contact element switches so as to signal as a switching event the occurrence of the inward movement of the display assembly 220 or its surface 120. The user may interact with the display surface 120 by either (i) applying sufficient force to move at least the portion of the display assembly inward and actuate the element 232 on the layer 230, or (ii) applying insufficient force to actuate the element 232 while contacting the display surface. In either case, an embodiment provides that the sensor components 222 is configured to detect a position of the object making contact with the display. In the latter case where the element 232 is not actuated by contact from the object, the processor 250 may be configured to either ignore the interaction, or interpret the interaction as some form of input, such as trace input (e.g. handwriting or “ink” input).

If the contact element 232 is actuated, the processor 250 is configured to associate the position of the object making contact with the display surface 120 with an input value. The input value may be one that is assigned to a region that includes or is proximate to the point of contact. As described with one or more embodiments, the processor may display buttons or icons in interface regions 128. The interface regions 128 may have pre-determined values assigned to individual soft buttons, so that each point in the region of the displayed button or icon may have the same value. If the position of the object in contact with the display (when the display assembly is pushed inwards to actuate the contact element 232) coincides with an area of the display surface 120 encompassed by one of the soft buttons, the processor 250 identifies the input value assigned to the particular soft-button or feature. The input value may be, for example, a character input (alphabet, numeric, special character), or functional (e.g. application launch, display or device control, menu launch).

An embodiment such as described enables the processor 250 to ignore any contact with the interface region 128 of the display surface 120 when the contact does not result in the contact element 232 switching. This enables the processor to distinguish incidental input from deliberate user-input. In one embodiment, the ability of the processor 250 to distinguish some incidental input promotes a design in which core aspects of the user-interface of the device are provided as soft buttons. In such a design, accidental use of the soft buttons is limited or made equivalent to mechanical buttons.

While an embodiment of FIG. 2A provides for the display assembly or its exterior surface to pivot inwards, an alternative embodiment includes a display assembly that can translate inward slightly with contact with an object. FIG. 2B illustrates an alternative implementation for display assembly 220, as viewed along lines B-B of FIG. 1. In FIG. 2B, neither end of the display surface or component pivot. Rather, the device resides on a deformable layer 270, which in turn rests on a ledge 272. The deformable layer may deform slightly with contact from the user, causing a carriage 275 or underside of the display assembly to move inward. The carriage 275 may contact the electrical element 232 when sufficient force is applied to sufficiently deform the layer 270.

Numerous other variations may be used to enable the display assembly 220 to move inward. One or more embodiments assume the display assembly is rigid, such as provided by an LCD type display. However, other embodiments contemplate use of flexible display surfaces for providing features described with embodiments herein. These include, for example, E-INK (as manufactured by E-INK CORP.) display technology.

FIG. 2C illustrates an alternative implementation for display assembly 220, as viewed along lines A-A of FIG. 1. An embodiment of FIG. 2C replaces switch element 232 and optionally the electrical contact layer 230 with a force sensor 282, provided on a sensor layer 282. The force sensor 282 may be able to measure force, rather than distance, as applied with a contact of an object to the display. FIG. 2C illustrates this point by providing a force sensor 282 to abut the display assembly 2220. The magnitude of the force may provide the threshold by which contact is incidental or a graze, versus deliberate or otherwise distinguishable. As such, the distance that display surface 120 (and/or display assembly 220) travels/pivots with contact may be negligible, and possibly not noticeable to the user.

According to an embodiment, the force sensor 282 is resistive, so as to change resistance when force (i.e. pressure) is present. The force sensor 282 may be tied to the processing resource to enable a user or manufacturer to change the settings of the force sensor 282. For example, the force sensor 282 may be made to be more sensitive, so that light contact may be deemed deliberate. Additionally, the processor 250 may use algorithms that reference position information (from sensors 224) with output from the force sensor. For example, in a hinge construction, the processor 250 may realize that contact with some regions of the display may incur less moment and thus apply less pressure, even though from the user's perspective, the force applied should be sufficient. In such a scenario, the processor may implement an algorithm to adjust threshold force levels based on the position where the contact is received.

In an embodiment, the force sensor 282 may be provided on a substrate or other thickness that supports its use within the device. The sensor platform 280 may correspond to any depth (provided as discrete or continuous elements) that contains one or more force sensors 282, which themselves may be in the form of modules. The sensor platform 280 may also include interconnectivity elements, such as wiring, to electrically couple force sensors in use with processing resources and other components. Still further, one or more embodiments further contemplate use of a sensor platform 280 that includes multiple force sensors 282. The processor can sum force outputs from multiple sensors, reference position information, and based on the position of the object, make a more accurate determination as to whether the input was deliberate, distinguishable as selection input etc.

### Methodology

FIG. 3 illustrates a programmatically implemented method by which a device or its processing resources may process input made through contact with a display surface of the device, under an embodiment of the invention. A method such as described with FIG. 3 may be implemented using, for example, a device with a moving display assembly, such as shown with an embodiment of FIG. 2A. Accordingly, reference to elements of FIG. 1, FIG. 2A or FIG. 2C may be made for purpose of illustrating a component or element that is suitable for performing a step of sub-step being described.

Step 310 provides that one of more soft-features are provided on a region or portion of the display surface 120. The features may take the form of buttons (i.e. “soft buttons”), keys, menu items or other features. Each feature may be assigned a set of coordinates, defining an area of the feature on the display surface 120.

In a step 320, an occurrence of a contact with the display surface 120 is detected, and a determination is made as to whether the contact satisfies a designated threshold criteria. The determination may be made programmatically, as in the case where force sensors are used. Alternatively, the determination may be made inherently through the structure of the assembly, as in the case when travel of the display surface is to actuate an electrical contact. Thus, as described with an embodiment of FIG. 2A and FIG. 2C, the threshold criteria may correspond to (i) the amount of distance that the display surface 120 moved inward (See FIG. 2A), and/or (ii) the amount of force applied to the display surface when it moved inward (see FIG. 2C). The threshold distance may be defined by separation between the underside of the display assembly or surface and the electrical actuation layer 230. The threshold force may be determined by, for example, information provided from force sensor 282 (FIG. 2C) or alternatively, with the structure of the electrical contacts, which may inherently require some measure of force to switch. For example, many contact domes require a force in the range of 140-210 Newtons to collapse. As an alternative, biasing mechanisms such as deformable gaskets and layers may be used that have their own characteristic force enabling the display surface 120 to move inward the sufficient distance. Numerous other variations to including biasing forces may be incorporated with one or more embodiments.

If the determination or result of step 320 is that the contact was insufficient or does not satisfy the threshold, an embodiment provides that the contact by the object is ignored. For example, the contact may be assumed incidental. As an alternative, an embodiment provides that the contact is detectable, but interpreted as an alternative form of input. For example, the contact by the object may be interpreted as trace or directional input.

When the determination of step 320 is that the contact met the threshold for being sufficient, the position of the object in contact with the display is determined in step 330. In one embodiment, sensor components 224 may be used, for example, to track and/or record the position of the object when it makes contact with the display surface. At an instant when the occurrence of step 320 is detected, the position of the object may be determined.

Step 340 provides that the position of the object is identified as being within a boundary of a region for a particular soft button or feature. As such, a soft-feature or button is identified from the position of the object when the occurrence of step 320 is detected. Accordingly, one embodiment provides that the combination of the sufficiency determination of step 320 and the position of the object as determined in step 330 are interpreted as selection input by the processor 250. The selection input may be for the particular soft button or feature that contains the contact coordinate of the object when the occurrence of step 320 is detected.

### Sliding Housing Assembly

Embodiments such as described above and with FIG. 1 thru FIG. 3 may be implemented on a mobile computing device having a sliding housing construction. A device with a sliding housing construction may extend and contract in length to expose or hide features or portions thereof.

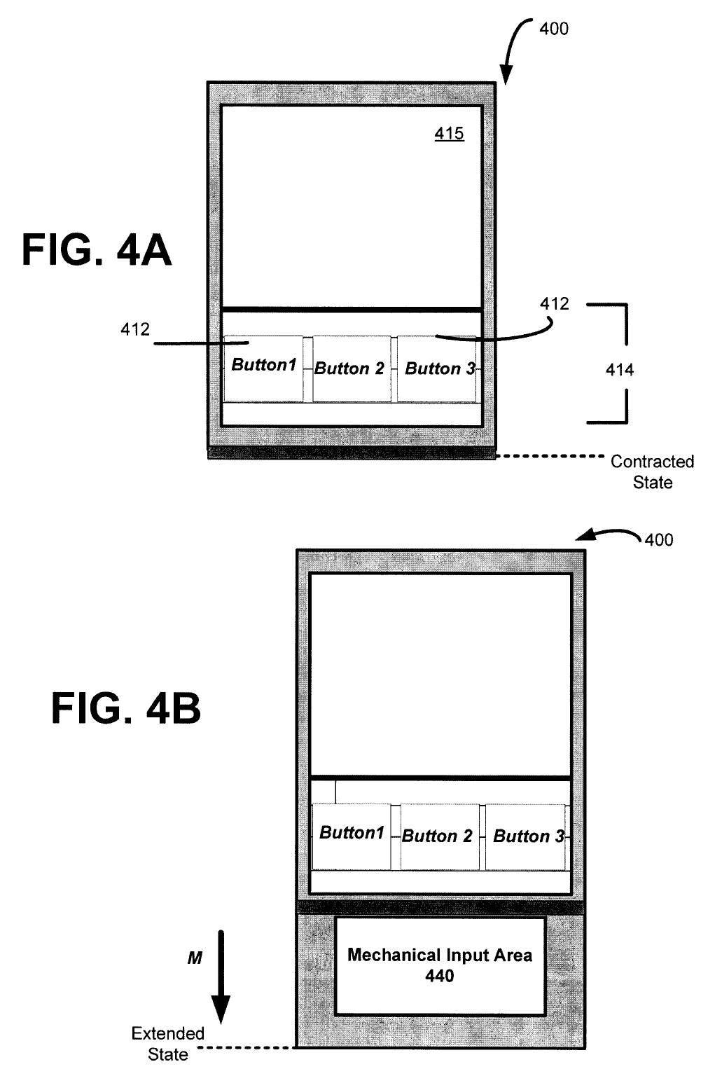

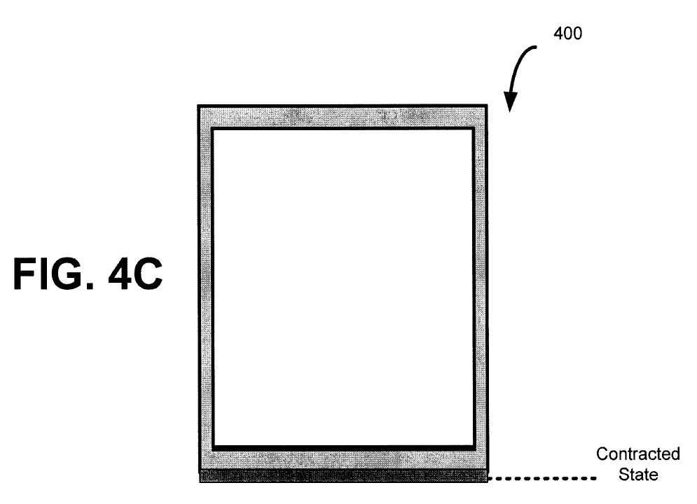

FIG. 4A thru FIG. 4C illustrate one embodiment in which a device 400 may implement a sliding housing construction in connection with a moveable display and soft-features. FIG. 4A illustrates device 400 in a contracted state, with a select set of soft buttons 412 displayed on a lower region 414 of a display surface 415 of device 400. The soft buttons 412 may be selectable with user-contact to move the display surface inward to satisfy distance and/or force threshold for registering the movement as an event. No selection input may be registered with for soft buttons 412 if the contact with the display surface fails to satisfy the threshold of force or alternatively of the inward moving display. Thus, for example, incidental contact with region 414 may be distinguishable and ignored.

FIG. 4B illustrates device 400 in an extended state to expose a mechanical input area 440. The extended state may be achieved with linear motion along directional arrow M. The mechanical input area 440 may take several forms, such as a keypad or keyboard. Other features may be provided in addition or as an alternative to the mechanical input area 440, such as a second display surface (from another display assembly which may or may not be moveable inward), a lens or microphone/speaker.

In one embodiment, the soft buttons 412 are persistent on a dedicated portion of the display surface 415. For example, the soft buttons 412 may appear anytime the device 400 is turned on. In another embodiment, the soft buttons 412 are semi-persistent, such as being displayed whenever the device is in a particular mode. For example, soft buttons 412 may be displayed whenever a particular application is in use. As an alternative or addition, the soft buttons 412 may be swapped with other buttons, depending on the application that is in use. FIG. 4C illustrates an embodiment in which the device is operable to cause the soft buttons 412 to be hidden or disappear from view. While FIG. 4C shows the device 400 in the contracted state, the soft buttons 412 may be eliminated or hidden from view when the device is in the extended state.

In another implementation, the device 400 may be operable in both a landscape and portrait mode. In landscape mode, for example, the device may display video content or have use that does not require soft buttons 412. As such, the buttons 412 may be hidden or made to disappear when, for example, the device is switched from portrait to landscape mode.

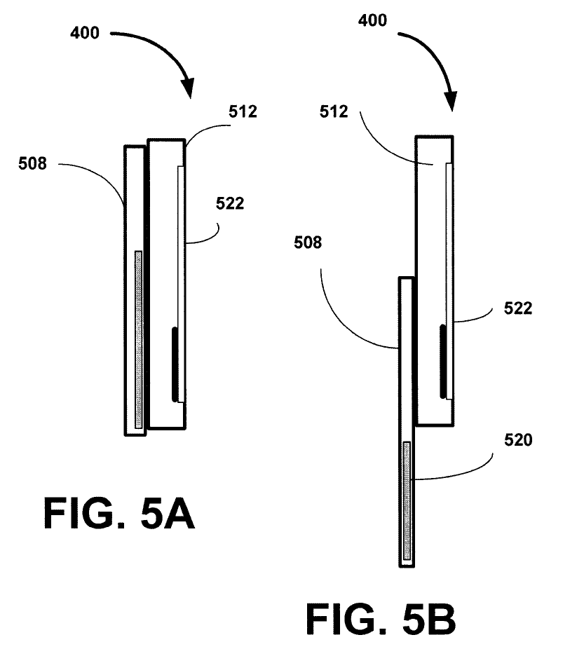

FIG. 5A and FIG. 5B illustrate the device 400 from a side perspective, under an embodiment. The housing 410 includes a first or lower housing segment 508 and a second or upper housing segment 512. In one implementation, the lower housing segment 508 includes a keyboard or keypad 520. The upper housing segment 512 includes a display surface 522. In one embodiment, the display surface 522 may be constructed to be inwardly moveable, through slight pivot or insertion, such as described with one or more other embodiments provided for in this application. As an alternative, the display surface 520 may be coupled or combined with a force sensor. In such an embodiment, the display surface may pivot or insert a negligible (or unnoticeable) amount.

Various configurations and constructions for enabling the sliding housing design may be used. For example, as illustrated with an embodiment of FIG. 5A and FIG. 5B, housing segments 508, 512 may slide against one another. Lower housing segment 508 may contain peripheral slots that engage extensions on the upper housing segment 512, so as to create linear tracks by which the second housing segment can slide up and down between contracted and extended positions.

Alternatively, housing segments may telescope-meaning lower housing segment 508 contains the upper housing segment 512 when it moves upward or downward. Such containment may be peripheral, meaning the entire periphery of the upper housing segment 512 may, on at least one cross-section, be contained within a section of the lower housing segment 508.

Numerous alternative constructions are also contemplated. For example, housing segments 508, 512 may use “flip” construction, rather than a slider. In a flip construction, the housing segments 508, 512 are pivotally coupled such that the two housing segments pivot between closed and open positions.

### Soft Features

Various kinds of soft features may be implemented in accordance with one or more embodiments described herein. With an embodiment of FIG. 1, for example, soft buttons 129 may be displayed to perform core functions of the device, such as application launch, device or hardware (e.g. display) control, menu operations, and call answer or hang-up. One general advantage provided by displayed features such as soft buttons is that they can be removed, replaced, or altered in appearance and configuration. For example, the functionality or input value associated with each soft button 129 may be switched. As an alternative or addition, new soft buttons 129 may be provided to replace existing soft buttons 129. Still further, as another alternative or addition, the size and number of buttons that appear on a designated region of the display may be varied.

FIG. 6A illustrates an implementation of an embodiment in which soft buttons 612 are iconic in appearance on a display surface 620, to be selectable to perform a specific function or application operation. The soft buttons 612 may be provided in a region 618 of the display surface 620 that overlays force sensors and/or can be moved inwards. In the case where the display surface 620 is part of an assembly that enables one edge of the display to move inwards, one or more embodiments provide that the location of the display region 618 is off of the edge of the portion of the display that has the most pivot.

According to an embodiment, the buttons 612 have assignments to icons or other graphics. For example, an icon 614 may be assigned to a particular application. A selection input may be received with an object (such as a human finger) contacting the display 620 on the soft button 612 with sufficient force to push the display inward or alternatively be registered by force sensor 282 (FIG. 2C). In response to the selection input, the operation or function assigned to the selected soft button is performed. The function or operation of the selected soft button 612 may correspond to, for example, a launch or use of the corresponding application.

Furthermore, under an embodiment, the appearance of individual icons 614 may be altered with settings or user-input. For example, icons 614 may be changed in color, size or other appearance.

In one embodiment, the display region 618 where soft buttons 612 are provided is persistent, so as to be present when display 620 is operational. In an embodiment, the display region 618 is persistent when the device is in a particular mode of operation. Still further, the display region 618 may disappear or re-appear depending on user preferences, input or other conditions.

As an alternative or addition, an embodiment of FIG. 6B illustrates the device 600 may be configured to provide a soft keyboard 640 on the display region 618. In an embodiment, the display region 618 is dynamically configurable to provide the keyboard 640 as an alternative soft feature mechanisms for display surface 620. The soft keyboard 640 may comprise a plurality of keys, corresponding to, for example, a QWERTY arrangement for a keyboard. The sensor component 224 (see FIG. 2A) may be able to distinguish the position of the object on the display surface 620 with sufficient granularity to identify which key receives an object in contact with the region 618. As described with one or more other embodiments, the position information may be combined with sufficiency determinations relating to the magnitude of the contact. Such sufficiency determinations may correspond to the display surface 620 being pushed in by the contacting object and/or force sensor 282 (FIG. 2C) providing force output that exceeds a threshold. The combination of the display surface 620 being pushed in and the position information may be interpreted as a key selection by a processor of the device.

In addition to enabling new soft-feature mechanisms to be provided, one embodiment provides that the display region 618 may be adjusted in size, shape, location or appearance. Thus, the display region 618 may be a dynamic and/or configurable feature, rather than a static or persistent feature.

### Hardware Design

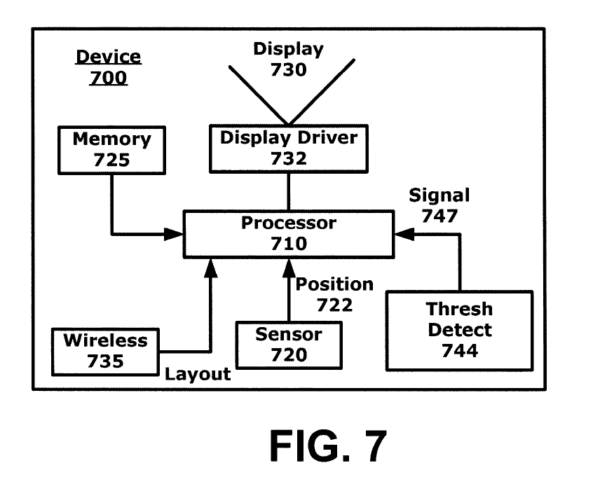

FIG. 7 is a simplified hardware diagram of a computing device configured to implement one or more embodiments of the invention. In an embodiment, a device 700 includes a processor 710, sensors 720, a display assembly 730, and a display driver 732 for the display assembly 730. The processor 710 may generate content corresponding to the soft-keys or buttons that are used with embodiments described herein. As described with embodiments, the display assembly 730 may include at least an exterior display surface that is coupled to a threshold detector 744. The threshold detector 744 may be electro-mechanical, such as provided by the display surface being moveable inward to cause actuation of an underlying snap-dome. Alternatively, the threshold detector 744 may be a force sensor that measures the applied force to the display surface. A signal 747 may result from the threshold detector 744. The threshold detector 744 be provided on or as part of a platform or other element on which an electrical actuation or sensor layer is provided. The display assembly may be moveable or pivotable inward, and depending on whether a force sensor or contact element is used, the amount of travel or movement may be negligible. Other components such as memory resources 725 and wireless communication component 735 may be provided in the device. Device 700 may be configured to implement functionality such as described with, for example, an embodiment of FIG. 1 thru FIG. 3, or FIG. 6A or FIG. 6B.

Sensors 720 may couple to processor 710 to provide position information 722 of an object in contact with a display surface of the display assembly 730. In one embodiment, the position information 722 may identify a specific region or coordinate that coincides with a soft feature, such as a displayed button on a region of the display 732. The threshold detector 744 may trigger with sufficient contact on the display surface. The processor 710 may interpret the combination of triggering signals from the threshold detector 744 and position information 722 from sensors 720 as a soft-key press events, associated with a specific key identified from the position information.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computing device comprising:
a housing;
a processor provided within the housing;
a force sensor;
a display assembly provided with a portion of the housing to provide a display surface, wherein the display assembly is structured so that at least a portion of the display surface is in contact with or in sufficient proximity to the force sensor;
one or more position sensors provided with or as part of the display assembly to detect a position of an object that makes contact with the display surface, wherein the one or more position sensors signal the position of the object to the processor; and
wherein when the computing device is operational, the force sensor provides an output to the processor that enables the processor to determine whether a given contact exceeds a threshold criteria;
wherein the processor is configured to interpret a selection input from a combination of the detected position from the one or more position sensors and the output of the force sensor.

2. The computing device of claim 1, wherein the processor is configured to generate one or more soft buttons in the portion of the display surface, and wherein the processor is configured to interpret the selection input as a selection of a soft button or icon.

3. The computing device of claim 2, wherein the processor is configured to generate a plurality of soft buttons in the portion of the display surface, and wherein the processor is configured to interpret the selection input as a selection of one of the plurality of soft buttons by determining which of the one or more soft buttons is displayed over an area that coincides or is most proximate to the detected position of the object making the given contact.

4. The computing device of claim 1, wherein the one or more position sensors are capacitive sensors.

5. The computing device of claim 1, wherein the force sensor uses electrical resistance to provide a measurement of an applied force with a given contact.

6. The computing device of claim 1, wherein the display surface moves inward slightly to enable the force sensor to provide the output.

7. The computing device of claim 1, wherein the housing includes a first housing segment and a second housing segment, wherein the first housing segment is slideably coupled to the second housing segment, and wherein the display assembly and the display surface are provided on the first housing segment.

8. The computing device of claim 7, further comprising a keypad, and wherein the keypad is provided on the second housing segment.

9. A computing device comprising:
a housing;
a processor provided within the housing;
a display assembly provided on a portion of the housing to provide a display surface, wherein at least a portion of the display surface is moveable inward into the housing with contact by an object to the display area;
one or more position sensors provided with or as part of the display assembly to detect a position of the object that makes contact with the display surface, wherein the one or more position sensors signal the position of the object to the processor; and
an electrical contact layer provided below at least a portion of the display surface, wherein the electrical contact layer is actuatable with contact or application of force resulting from inward movement of the display surface, and wherein the electrical contact layer is positioned so that, when the computing device is operational, inward movement of the display surface causes one of the one or more electrical contact elements to signal the processor;
wherein the processor is configured to (i) if the object makes sufficient contact with the portion of the display area to actuate the electrical contact layer, interpret a selection input from the detected position of the object; and (ii) if the object makes contact with the portion of the display surface without sufficient contact to actuate the electrical contact layer, either ignore the object making contact or interpret a non-selection input from the detected position of the object.

10. The computing device of claim 9, wherein the non-selection input corresponds to a trace input.

11. The computing device of claim 9, wherein the electrical contact layer comprises one or more electrical switches that are actuated with inward movement of the display surface.

12. The computing device of claim 11, wherein inward movement of the display surface results in inward movement of the display assembly.

13. The computing device of claim 9, wherein the housing includes a first housing segment and a second housing segment, wherein the first housing segment is slideably coupled to the second housing segment, and wherein the display assembly and the display surface are provided on the first housing segment.

14. The computing device of claim 13, further comprising a keypad, and wherein the keypad is provided on the second housing segment.

15. The computing device of claim 9, wherein one or more position sensors are capacitive sensors.

16. A method for processing input on a mobile computing device, the method comprising:
detecting an occurrence of at least a portion of a display surface on the mobile computing device translating inward to satisfy a threshold criteria;
determining a position of an object that causes the display surface to translate inward; and
determining a selection input from the position of the object responsive to detecting the portion of the display surface translating inward.

17. The method of claim 16, wherein the threshold criteria is determined from one of (i) a distance of the display surface translating inward, (ii) a force applied by the object in causing the display surface to translate inward, or (iii) a combination thereof.

18. The method of claim 16, wherein determining a position of an object includes capacitively determining the position.

19. The method of claim 16, further comprising generating a plurality of display features that are individual selectable on the display surface, and wherein determining a selection input includes determining which of the plurality of features are selected based on the position of the object when the inward translation of the display surface is detected.

20. The method of claim 16, wherein detecting an occurrence of at least a portion of a display surface on the mobile computing device translating inward includes receiving a signal from a contact element that is switched by the display surface on the mobile computing device translating inward.

21. The method of claim 16, wherein determining a position of an object includes using a capacitive sensor.

22. The method of claim 16, wherein detecting an occurrence of at least a portion of a display surface on the mobile computing device translating inward includes detecting the display surface pivoting inward with at least one end of the display surface being pinned.

23. A method for processing input on a mobile computing device, the method comprising:
detecting a contact by an object on a display surface that satisfies a threshold; determining a position of an object on the display surface using one or more position sensors; and
identifying an input from the position of the object making the detected contact, wherein the identified input is distinguishable from how the contact would be interpreted if the contact did not satisfy the threshold.

24. The method of claim 23, wherein detecting a contact by an object on a display surface includes determining a magnitude of a force applied with the contact using a force sensor that is coupled or integrated with the display surface.

25. The method of claim 23, wherein detecting a contact by an object on a display surface includes receiving an actuation signal from a contact element that is actuated by the display surface moving inward.
